(19) United States
(12) Patent Application Publication
(10) Pub. No.: US 2026/0190042 A1
(43) Pub. Date: Jul. 2, 2026

(54) COMMUNICATION METHOD, RELAY APPARATUS, AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/550,442

(22) Filed: Feb. 26, 2026

Related U.S. Application Data
(63) Continuation of application No. PCT/JP2024/030426, filed on Aug. 27, 2024.

(30) Foreign Application Priority Data
Aug. 28, 2023 (JP) 2023-138390
Aug. 28, 2023 (JP) 2023-138395

(51) Int. Cl. H04W 52/36; H04W 52/14

(52) U.S. Cl. CPC H04W 52/367; H04W 52/14

(57) ABSTRACT

Provided is a communication method executed by a relay apparatus including a relay device that performs relay transmission of relaying a radio signal transmitted between a network node and a user equipment, and a control terminal used to control the relay device, the communication method including: receiving, by the control terminal, power control information for controlling a transmission power of the relay transmission from the network node; and performing, by the relay device, the relay transmission at the transmission power based on the power control information. The power control information includes at least one selected from the group consisting of first information indicating a maximum transmission power and/or a maximum gain to be set in the relay device, second information indicating a transmission power and/or a gain in periodic relay transmission, and third information indicating a transmission power and/or a gain in aperiodic relay transmission.

### RELATED APPLICATIONS

The present application is a continuation based on PCT Application No. PCT/JP2024/030426, filed on Aug. 27, 2024, which claims the benefit of Japanese Patent Application No. 2023-138390 filed on Aug. 28, 2023 and Japanese Patent Application No. 2023-138395 filed on Aug. 28, 2023. The content of which is incorporated by reference herein in their entirety.

### TECHNICAL FIELD

The present disclosure relates to a communication method, a relay apparatus, and a network node used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a network node (for example, a base station) is a problem. In order to solve such a problem, a repeater apparatus that is a type of relay apparatus that performs relay transmission of relaying radio signals between a network node and a user equipment and can be controlled from the network node is attracting attention (see, for example, Non-Patent Document 1).

Such a repeater apparatus can extend the coverage of a network node while suppressing occurrence of interference by, for example, amplifying a radio signal received from a base station and transmitting the radio signal through directional transmission. Such a repeater apparatus is referred to as a network-controlled repeater (NCR).

### CITATION LIST

### Non-Patent Literature

Non-Patent Document 1: 3GPP Contribution: RP-213700, “New SI: Study on NR Network-controlled Repeaters”

### SUMMARY

A communication method according to a first aspect is a method executed by a relay apparatus including a relay device that performs relay transmission of relaying a radio signal transmitted between a network node and a user equipment, and a control terminal used to control the relay device. The communication method includes the steps of: receiving, by the control terminal, power control information configured to control a transmission power of the relay transmission from the network node; and performing, by the relay device, the relay transmission at the transmission power based on the power control information. The power control information includes at least one selected from the group consisting of first information indicating a maximum transmission power and/or a maximum gain to be set in the relay device, second information indicating a transmission power and/or a gain in periodic relay transmission, and third information indicating a transmission power and/or a gain in aperiodic relay transmission.

A relay apparatus according to a second aspect includes a relay device that performs relay transmission of relaying a radio signal transmitted between a network node and a user equipment, and a control terminal used to control the relay device. The control terminal receives power control information configured to control a transmission power of the relay transmission from the network node. The relay device performs the relay transmission at the transmission power based on the power control information. The power control information includes at least one selected from the group consisting of first information indicating a maximum transmission power and/or a maximum gain to be set in the relay device, second information indicating a transmission power and/or a gain in periodic relay transmission, and third information indicating a transmission power and/or a gain in aperiodic relay transmission.

A network node according to a third aspect is a node for communicating with a relay apparatus including a relay device that performs relay transmission of relaying a radio signal transmitted between the network node and a user equipment, and a control terminal used to control the relay device. The network node includes a controller configured to generate power control information configured to control transmission power of the relay transmission, and a transmitter configured to transmit the power control information to the control terminal. The power control information includes at least one selected from the group consisting of first information indicating a maximum transmission power and/or a maximum gain to be set for the relay device, second information indicating a transmission power and/or a gain in periodic relay transmission, and third information indicating a transmission power and/or a gain in aperiodic relay transmission.

A communication method according to a fourth aspect is a method executed by a relay apparatus including a relay device that performs relay transmission of relaying a radio signal transmitted between a network node and a user equipment, and a control terminal used to control the relay device. The communication method includes the steps of: acquiring a maximum value indicating a maximum transmission power and/or a maximum gain set in the relay device, and an estimated value indicating a transmission power and/or a gain of the relay transmission in the relay device; and transmitting margin information indicating a difference between the maximum value and the estimated value from the control terminal to the network node.

A relay apparatus according to a fifth aspect includes a relay device that performs relay transmission of relaying a radio signal transmitted between a network node and a user equipment, and a control terminal used to control the relay device. The control terminal transmits, to the network node, based on a maximum value indicating a maximum transmission power and/or a maximum gain set in the relay device, and an estimated value indicating a transmission power and/or a gain of the relay transmission in the relay device, margin information indicating a difference between the maximum value and the estimated value.

A network node according to a sixth aspect is a node for communicating with a relay apparatus including a relay device that performs relay transmission of relaying a radio signal transmitted between the network node and a user equipment, and a control terminal used to control the relay device. The network node includes a receiver configured to receive, from the control terminal, margin information based on a maximum value indicating a maximum transmission power and/or a maximum gain set in the relay device, and an estimated value indicating a transmission power and/or a gain of the relay transmission in the relay device. The margin information is information indicating a difference between the maximum value and the estimated value.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a radio interface of a user plane handling data.

FIG. 3 is a diagram illustrating a configuration of a protocol stack of a radio interface of a control plane handling signaling (control signal).

FIG. 4 is a diagram illustrating an example of an application scenario of an NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram illustrating an example of a configuration of a protocol stack in the NCR apparatus according to the first embodiment.

FIG. 8 is a diagram illustrating an example of the configuration of the NCR apparatus according to the first embodiment.

FIG. 9 is a diagram illustrating a configuration of a user equipment (UE) according to the embodiment.

FIG. 10 is a diagram illustrating an example of a configuration of a gNB (network node) according to the embodiment.

FIG. 11 is a flowchart illustrating a first basic operation of the NCR apparatus according to the first embodiment.

FIG. 12 is a flowchart illustrating a second basic operation of the NCR apparatus according to the first embodiment.

FIG. 13 is a flowchart illustrating an example of a first operation pattern of the mobile communication system according to the first embodiment.

FIG. 14 is a flowchart illustrating an example of a second operation pattern of the mobile communication system according to the first embodiment.

FIG. 15 is a flowchart illustrating an example of a third operation pattern of the mobile communication system according to the first embodiment.

FIG. 16 is a flowchart illustrating an example of a fourth operation pattern of the mobile communication system according to the first embodiment.

FIG. 17 is a diagram illustrating an example of an application scenario of a RIS apparatus (relay apparatus) according to a second embodiment.

FIG. 18 is a diagram illustrating an example of a configuration of the RIS apparatus according to the second embodiment.

### DESCRIPTION OF EMBODIMENTS

The relay apparatus described in the above “BACKGROUND OF INVENTION” is capable of amplifying the radio signal to be relayed, but no technology has yet been established for performing transmission power control that allows a network node to variably set the transmission power and/or the gain.

Therefore, the present disclosure aims to appropriately perform transmission power control of a relay apparatus.

A mobile communication system according to an embodiment will be described with reference to the drawings. In the description of the drawings, the same or similar parts are denoted by the same or similar reference numerals.

### (1) First Embodiment

A first embodiment will be described. A relay apparatus according to the first embodiment is a repeater apparatus (that is, an NCR apparatus) that can be controlled from a network.

### (1.1) Overview of Mobile Communication System

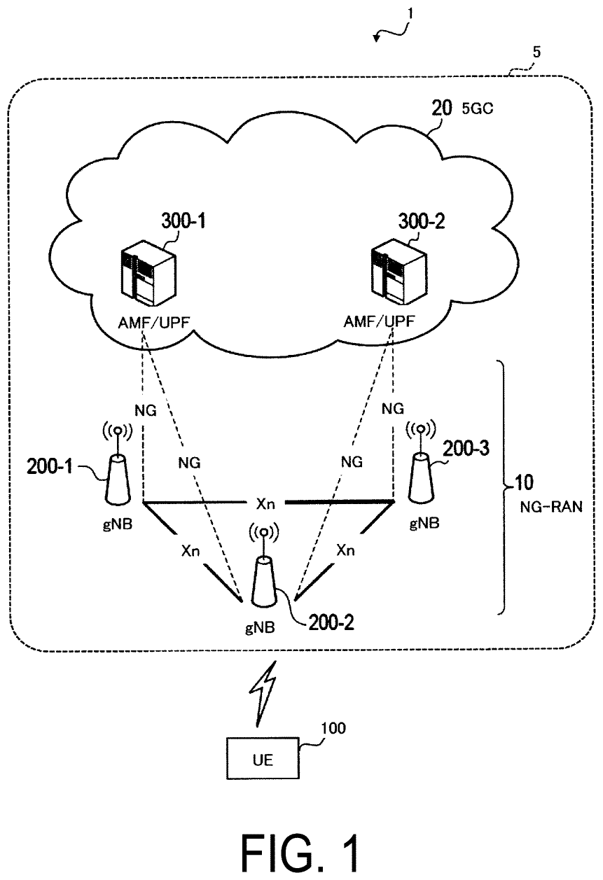

First, an overview of a mobile communication system 1 according to the first embodiment will be described. FIG. 1 is a diagram illustrating a configuration of a mobile communication system according to the first embodiment.

A mobile communication system 1 complies with the 5th Generation System (5GS) of the 3rd Generation Partnership Project (3GPP; trade name, the same applies below) standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (which may be a communication card or a chipset), a sensor or an apparatus provided on a sensor, a vehicle or an apparatus provided on a vehicle (Vehicle UE), and an aircraft or an apparatus provided on an aircraft (Aerial UE).

The NG-RAN 10 includes base stations (referred to as “gNBs” or “NG-RAN nodes” in a 5G system) 200, which is a type of network node. The gNBs 200 are connected to each other via an Xn interface, which is an inter-node interface (inter-base station interface). Each gNB 200 manages one or more cells. The gNB 200 performs wireless communication with the UE 100 that has established a connection to the cell of the gNB 200. The gNB 200 has a radio resource management (RRM) function, a routing function for user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to a neighboring base station via the Xn interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

The gNB can be connected to an Evolved Packet Core (EPC) corresponding to a core network of LTE. An LTE base station can also be connected to the 5GC. The LTE base station and the gNB can be connected via an inter-base station interface.

The 5 GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is a base station-core network interface.

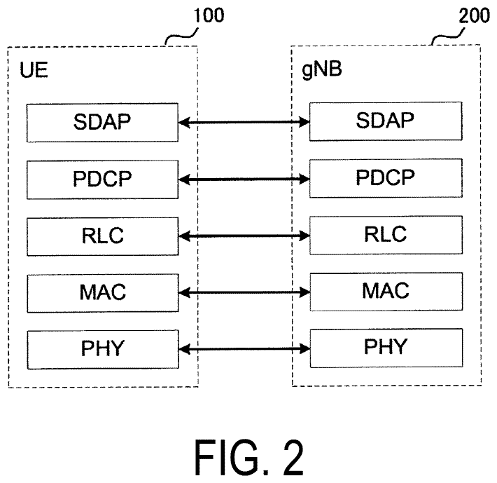

FIG. 2 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. The PHY layer of the UE 100 receives downlink control information (DCI) transmitted from the gNB 200 on a physical downlink control channel (PDCCH). Specifically, the UE 100 performs blind decoding of PDCCH using a radio network temporary identifier (RNTI) and acquires successfully decoded DCI as a DCI addressed to the UE. The DCI transmitted from the gNB 200 has CRC bits scrambled by the RNTI added thereto.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20 RB.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer uses the functions of the MAC layer and the PHY layer to transmit data to the RLC layer on the receiving side. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an internet protocol (IP) flow, which is a unit for a core network to control quality of service (QoS), and a radio bearer, which is a unit for an access stratum (AS) to control QoS. When the RAN is connected to an EPC, the SDAP is not necessary.

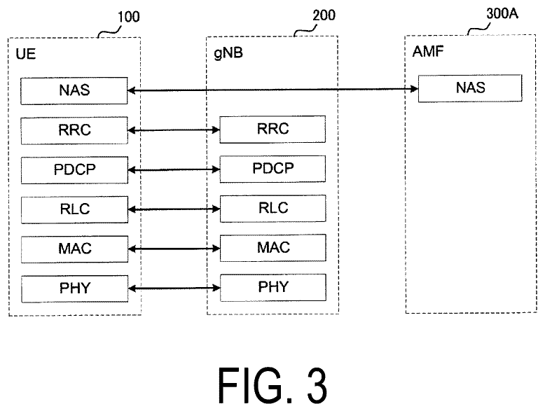

FIG. 3 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls the logical channel, the transport channel, and the physical channel according to the establishment, re-establishment and release of radio bearers. When there is a connection (RRC connection) between the RRC of the UE 100 and the RRC of the gNB 200, the UE 100 is in an RRC connected state. When there is no connection (RRC connection) between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. The UE 100 has an application layer and the like in addition to the radio interface protocol. A layer lower than the NAS layer is referred to as an Access Stratum (AS).

### (1.2) Example of Application Scenario of Relay Apparatus

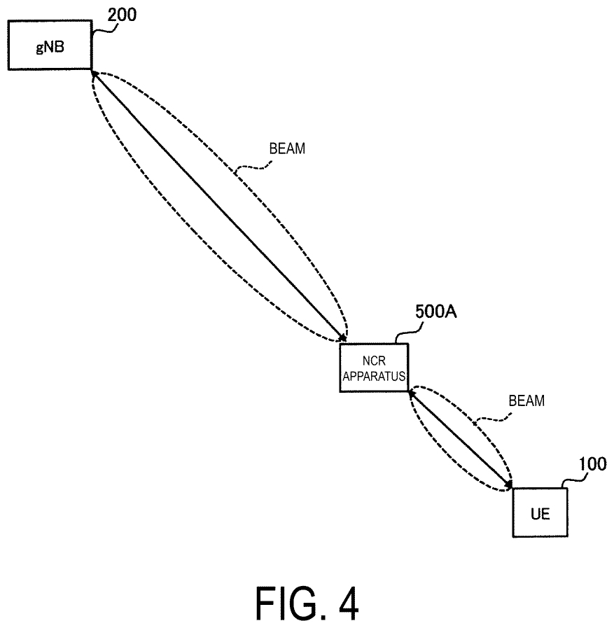

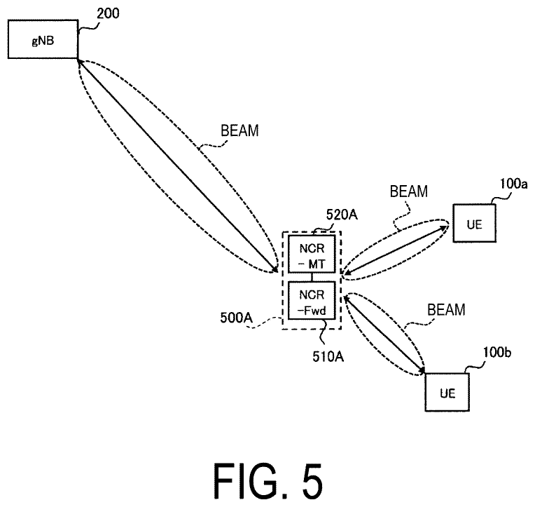

An application scenario of the NCR apparatus (relay apparatus) according to the first embodiment will be described. FIGS. 4 and 5 are diagrams illustrating an example of an application scenario of the NCR apparatus according to the first embodiment. The NCR apparatus may be referred to as an NCR node.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may be in a state of not being communicable with the gNB 200 within a line of sight because of obstacles existing between the gNB 200 and the UE 100.

As illustrated in FIG. 4, an NCR apparatus 500A is introduced into the mobile communication system 1, wherein the NCR apparatus 500A is a repeater apparatus as a type of relay apparatus relaying radio signals between the gNB 200 and the UE 100, and can be controlled from the network 5. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

As illustrated in FIG. 5, a new UE (hereinafter referred to as “NCR-MT (Mobile Termination)”) 100B, which is a type of control terminal for controlling the NCR apparatus 500A, is introduced. That is, the NCR apparatus 500A includes an NCR-Fwd (Forwarding) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has functions similar to those of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wirelessly. The NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be movable. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to forming a beam, the NCR-Fwd 510A may perform null forming (so-called null steering) toward the UE 100 which is not a communication partner (not illustrated) and/or a neighboring gNB 200 (not illustrated) to curb interference.

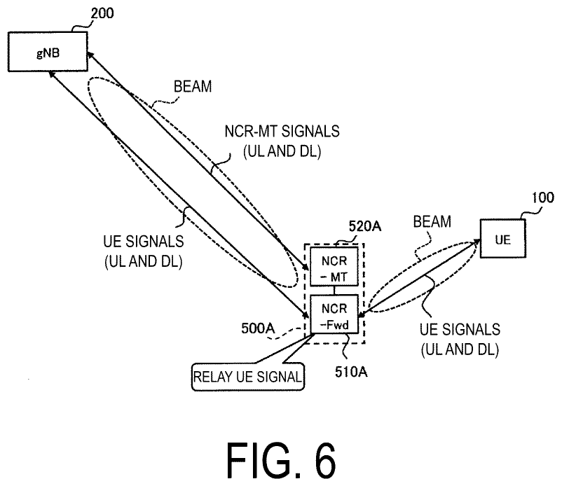

FIG. 6 is a diagram illustrating an example of a control method for the NCR apparatus 500A according to the first embodiment.

The NCR-Fwd 510A relays radio signals (also referred to as “UE signals”) between the gNB 200 and the UE 100. The UE signal includes an uplink signal transmitted from the UE 100 to the gNB 200 (also referred to as a “UE-UL signal”) and a downlink signal transmitted from the gNB 200 to the UE 100 (also referred to as a “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and/or receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A radio link between the NCR-MT 520A and the gNB 200 is also referred to as a “control link”.

The gNB 200 directs a beam toward the NCR-MT 520A based on the NCR-MT-UL signal from the NCR-MT 520A. Since the NCR apparatus 500A and the NCR-MT 520A are co-located, the beam is also eventually directed toward the NCR-Fwd 510A when the backhaul link and the control link have the same frequency and the gNB 200 directs a beam toward the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting and/or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

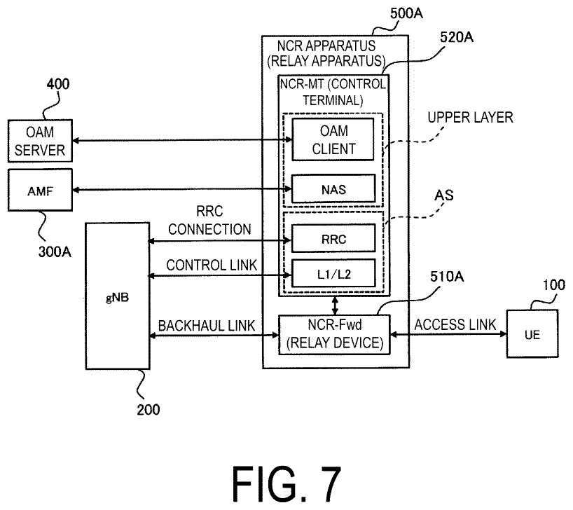

FIG. 7 is a diagram illustrating an example of a configuration of a protocol stack in the NCR apparatus 500A according to the first embodiment.

The NCR-Fwd 510A relays a radio signal transmitted and/or received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes entities of the layer 1 and/or the layer 2 (L1/L2), and each layer of the RRC and the NAS. The L1/L2 (in particular, PHY, MAC) and the RRC of the NCR-MT 520A are also referred to as the “AS of the NCR-MT 520A ”.

The NCR-MT 520A may include at least one selected from the group consisting of an operation, administration, maintenance (OAM) client communicating with an OAM server 400, a NAS layer communicating with the AMF 300A, and an F1 application protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and/or receives L1/L2 signaling to and from the gNB 200 via the control link. An RRC connection is established between the gNB 200 and the RRC of the NCR-MT 520A. The RRC of the NCR-MT 520A transmits and/or receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, an F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or a MAC CE) and used for static or quasi-static control of the NCR-Fwd 510A is also referred to as “NCR configuration information” or simply “configuration information”. Such configuration information may be referred to as “side control configuration”. Here, the RRC message may be an RRC reconfiguration message. The NCR configuration information includes, for example, information for configuring ON/OFF of the NCR-Fwd 510A. The NCR configuration information may include, for example, information on quasi-static beam configuration of the NCR-Fwd 510A.

On the other hand, the NCR control signal transmitted in the L1/L2 signaling, that is, the DCI (and/or the MAC CE) and used for dynamic control of the NCR-Fwd 510A is also referred to as “NCR control information” or simply “control information”. The NCR control information may be referred to as “side control information”. Cyclic redundancy code (CRC) bits of the PDCCH carrying the NCR control information are scrambled by a newly introduced dedicated RNTI. The dedicated RNTI is also referred to as “NCR-RNTI”. The NCR control information may include, for example, information on dynamic beam control of the NCR-Fwd 510A. The NCR configuration information may include information for instructing dynamic On/Off of the NCR-Fwd 510A.

For example, when the NCR-MT 520A is in an RRC connected state, the NCR apparatus 500A can turn on or off the NCR-Fwd 510A according to the NCR control information received from the gNB 200. On the other hand, after the NCR-MT 520A transitions to an RRC inactive state, the NCR apparatus 500A can turn on or off the NCR-Fwd 510A in accordance with the latest (last) configuration information received from the gNB 200.

The NCR control signal (for example, NCR configuration information by RRC and/or NCR control information by L1/L2 signaling) held by the NCR apparatus 500A (NCR-MT 520A) may be referred to as an NCR-Fwd context.

When a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information designating a center frequency of a radio signal (for example, a component carrier) that is a relay target in the NCR-Fwd 510A. When the NCR control signal received from the gNB 200 includes frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information designating an operation mode of the NCR-Fwd 510A. The mode control information may be associated with the frequency control information (center frequency). The operation mode may be any one of a mode in which the NCR-Fwd 510A performs omnidirectional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (configured) from the gNB 200 to the NCR-MT 520A. The mode in which the NCR-Fwd 510A performs transmission and/or reception with a variable directional beam may be a mode in which analog beamforming is performed. The mode may be a mode in which digital beamforming is performed. The mode may be a mode in which hybrid beamforming is performed. The mode may be a mode in which an adaptive beam specific to the UE 100 is formed. Any of these modes may be designated (configured) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode in which single-user (SU) spatial multiplexing is performed. The mode may be a mode in which Multi-User (MU) spatial multiplexing is performed. The mode may be a mode in which transmission diversity is performed. Any of these modes may be designated (configured) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (configured) from the gNB 200 to the NCR-MT 520A in the NCR control signal.

The NCR control signal may include beam control information designating a transmission direction, a transmission weight, or a beam pattern when the NCR-Fwd 510A performs directional transmission. The beam control information may be associated with the frequency control information (center frequency). The beam control information may include a precoding matrix indicator (PMI). The beam control information may include beamforming angle information. When the NCR control signal received from the gNB 200 includes beam control information, the NCR-MT 520A (controller 523) controls the NCR-Fwd 510A such that the NCR-Fwd 510A forms a transmission directivity (beam) indicated by the beam control information. Since the NCR control signal includes the beam control information, the gNB 200 can control the transmission directivity of the NCR apparatus 500A via the NCR-MT 520A.

The NCR control signal may include power control information designating a degree (gain) by which the NCR-Fwd 510A amplifies the radio signal or the transmission power. The power control information may be information indicating a difference value (that is, a relative value) between a current gain or transmission power and a target gain or transmission power. When the NCR control signal received from the gNB 200 includes power control information, the NCR-MT 520A (controller 523) controls the NCR-Fwd 510A such that the NCR-Fwd 510A performs change to the gain or the transmission power to that indicated by the transmission power control. The power control information may be associated with the frequency control information (center frequency). The power control information may be information designating any one of an amplifier gain, a beamforming gain, and an antenna gain of the NCR-Fwd 510A. The power control information may be information designating a transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

Next, an example of a configuration of each apparatus in the mobile communication system 1 according to the first embodiment will be described.

### (1.3.1) Example of Configuration of Relay Apparatus

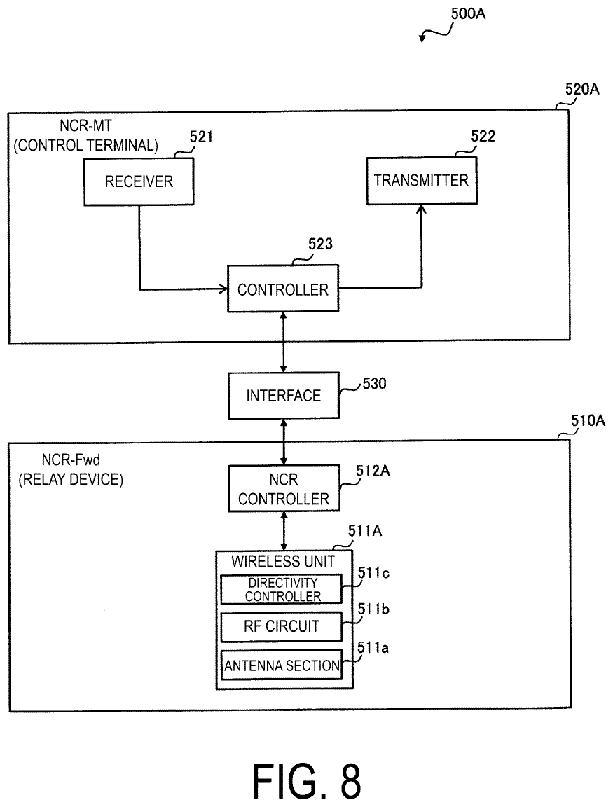

FIG. 8 is a diagram illustrating an example of the configuration of the NCR apparatus 500A (relay apparatus) according to the first embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna section 511a including a plurality of antennas (a plurality of antenna elements), an RF circuit 511b including an amplifier, and a directivity controller 511c that controls directivity of the antenna section 511a. The RF circuit 511b amplifies and relays (transmits) radio signals transmitted and/or received by the antenna section 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal (wireless signal) received by the antenna into a baseband signal (a reception signal) and outputs the resulting signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the resulting signal from an antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores programs executed by the processor and information used in processing by the processor. The processor may include a baseband processor and a central processing unit (CPU). The baseband processor performs modulation and demodulation, coding and decoding, and the like of a baseband signal. The CPU executes programs stored in the memory to perform various processes. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In the first embodiment, the receiver 521 of the NCR-MT 520A receives signaling (NCR control signal) used for control of the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

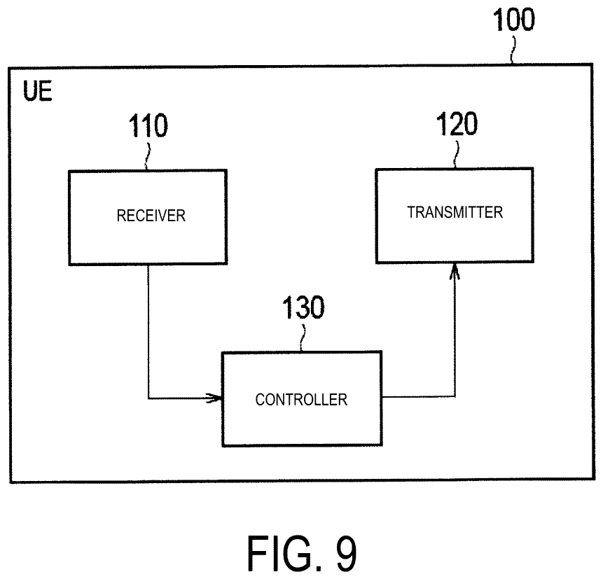

FIG. 9 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received by the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal from an antenna.

The controller 130 performs various controls and processes in the UE 100. Such processing includes processing of respective layers to be described later. The operations of the UE 100 described above and to be described below may also be an operation under control of the controller 130. The controller 130 includes at least one processor and at least one memory. The memory stores programs executed by the processor and information used in processing by the processor. The processor may include a baseband processor and a CPU. The baseband processor performs modulation and demodulation, coding and decoding, and the like of a baseband signal. The CPU executes programs stored in the memory to perform various processes.

### (1.3.3) Example of Configuration of Network Node

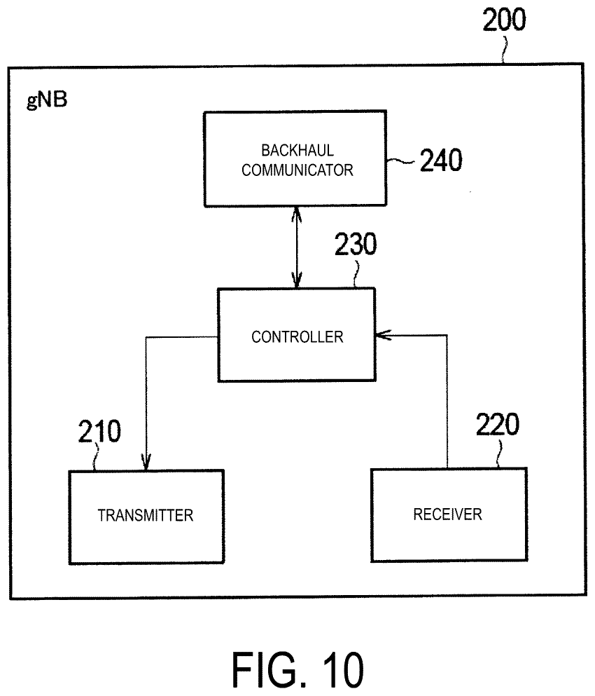

FIG. 10 is a diagram illustrating an example of a configuration of the gNB 200 (network node) according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal from an antenna. The receiver 220 performs various types of reception under control of the controller 230. The receiver 220 includes an antenna and a reception device. The reception device converts a radio signal received by the antenna into a baseband signal (a reception signal) and outputs the resulting signal to the controller 230. The transmitter 210 and the receiver 220 may be capable of beamforming using a plurality of antennas.

The controller 230 performs various types of control in the gNB 200. The operations of the gNB 200 described above and to be described below may also be an operation under control of the controller 230. The controller 230 includes at least one processor and at least one memory. The memory stores programs executed by the processor and information used in processing by the processor. The processor may include a baseband processor and a CPU. The baseband processor performs modulation and demodulation, coding and decoding, and the like of a baseband signal. The CPU executes programs stored in the memory to perform various processes.

The backhaul communicator 240 is connected to a neighboring base station via the inter-base station interface. The backhaul communicator 240 is connected to the AMF/UPF 300 via the base station-core network interface. The gNB may include a Central Unit (CU) and a Distributed Unit (DU) (that is, functions are divided), and both units may be connected via an F1 interface.

In the first embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Operation of Mobile Communication System

Next, an operation of the mobile communication system 1 according to the first embodiment will be described.

### (1.4.1) Basic Operation

The basic operation according to the first embodiment is an operation related to the NCR apparatus 500A. The NCR apparatus 500A is a RAN node including an NCR-Fwd 510A and an NCR-MT 520A. The NCR-Fwd 510A performs relay transmission between the gNB 200 and the UE 100, specifically, amplifies and relays (forwarding) UL/DL RF signals. The operation of the NCR-Fwd 510A is controlled according to side control information (NCR control signal) received by the NCR-MT 520A from the gNB 200. The NCR-MT 520A communicates with the gNB 200 via a control link to receive side control information. The control link is based on the NR Uu interface.

The NCR-Fwd 510A is capable of amplifying the radio signal (RF signal) to be relayed, but no technology has yet been established for performing transmission power control that allows the gNB 200 to variably set the transmission power and/or the gain. In the following first embodiment, an operation that enables appropriate transmission power control of the NCR-Fwd 510A will be described.

### (1.4.1.1) First Basic Operation

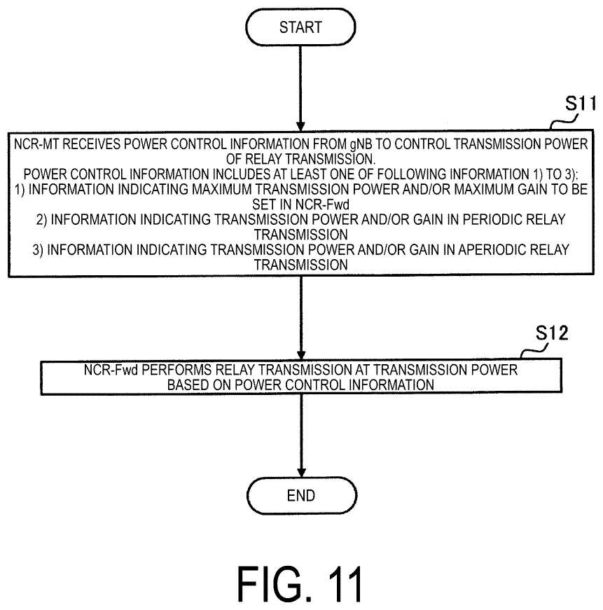

FIG. 11 is a flowchart illustrating a first basic operation of the NCR apparatus 500A according to the first embodiment.

In step S11, the NCR-MT 520A receives, from the gNB 200, power control information for controlling the transmission power of relay transmission. The power control information may be a type of side control information (NCR control signal) transmitted on the control link. The gNB 200 may transmit, to the NCR-MT 520A, at least one selected from the group consisting of a radio resource control (RRC) message including power control information, a medium access control/control element (MAC CE) including power control information, and downlink control information (DCI) including power control information.

The power control information may be information for controlling a transmission power in a downlink direction (DL) from the NCR-Fwd 510A to the UE 100. The power control information may be information for controlling the transmission power in an uplink direction (UL) from the NCR-Fwd 510A to the gNB 200. The power control information may be information for controlling the transmission power of both DL and UL.

The power control information for controlling the transmission power of the relay transmission includes at least one of the following information 1) to 3):
1) First information indicating maximum transmission power (also referred to as “maximum operating transmission power”) and/or maximum gain (also referred to as “maximum operating gain”) to be set in the NCR-Fwd 510A:
A specific example of an operation using the first information will be described later in a first operation pattern.
2) Second information indicating transmission power (also referred to as “repetition transmission power”) and/or gain (also referred to as “repetition gain”) in periodic relay transmission (repeated relay transmission):
A specific example of an operation using the second information will be described later in a ssecond operation pattern.
3) Third information indicating transmission power (also referred to as “dynamic transmission power”) and/or gain (also referred to as “dynamic gain”) in aperiodic relay transmission (single relay transmission):
A specific example of an operation using the third information will be described later in a third operation pattern.
In step S12, the NCR-Fwd 510A performs relay transmission at the transmission power based on the power control information received in step S11. When the power control information received in step S11 includes the first information, step S12 includes a step of performing relay transmission so as not to exceed the maximum transmission power and/or the maximum gain based on the first information. When the power control information received in step S11 includes the second information, step S12 includes a step of performing periodic relay transmission at a transmission power based on the second information. When the power control information received in step S11 includes the third information, step S12 includes a step of performing aperiodic relay transmission at a transmission power based on the third information.

The transmission power (output power) of the NCR-Fwd 510A that relays and transmits the radio signal is determined according to the reception power and power amplification degree (gain) of the radio signal. The power amplification degree may be the ratio of the transmission power to the reception power, and the gain may be the power amplification degree in decibels (dB). When the maximum transmission power (and/or the maximum gain) is designated by the first information, the NCR-Fwd 510A may control the gain (specifically, the amplifier) so that it does not exceed the designated maximum transmission power (and/or maximum gain). When the transmission power (and/or the gain) is designated by the second information or the third information, the NCR-Fwd 510A may control the amplifier so that the transmission power (and/or the gain) becomes the designated value.

According to the first basic operation, the gNB 200 can variably set the transmission power and/or the gain when the NCR-Fwd 510A relays a radio signal (an RF signal). Therefore, the gNB 200 can appropriately control the transmission power of the NCR-Fwd 510A.

The NCR apparatus 500A that performs such operations includes an NCR-MT 520A that receives, from the gNB 200, power control information for controlling the transmission power of relay transmission, and an NCR-Fwd 510A that performs relay transmission at a transmission power based on the power control information. On the other hand, the gNB 200 that communicates with the NCR apparatus 500A (the NCR-MT 520A) includes a controller 230 that generates power control information for controlling the transmission power of relay transmission, and a transmitter 210 that transmits the power control information to the NCR-MT 520A.

The power control information may include information designating a period (timing) during which transmission power control according to the power control information is applied. The NCR-MT 520A may perform relay transmission at the transmission power based on the power control information during the designated period (timing).

Step S11 may include a step of receiving first power control information including a setting list in which setting values of a transmission power or a gain are associated with indices that indicate the setting values, and a step of receiving second power control information that includes the indices. For example, the NCR-MT 520A may receive first power control information including a setting list from the gNB 200 via an RRC message, and then receive an index (second power control information) indicating a setting value in the setting list from the gNB 200 via a MAC CE or DCI. Step S12 may include a step of specifying a setting value corresponding to the index included in the second power control information based on the setting list, and a step of performing transmission power control using the specified setting value. In this way, the gNB 200 may set a list of indexed value ranges of a transmission power or a gain in the NCR-MT 520A in advance, and use the index when designating the actual transmission power or gain.

### (1.4.1.2) Second Basic Operation

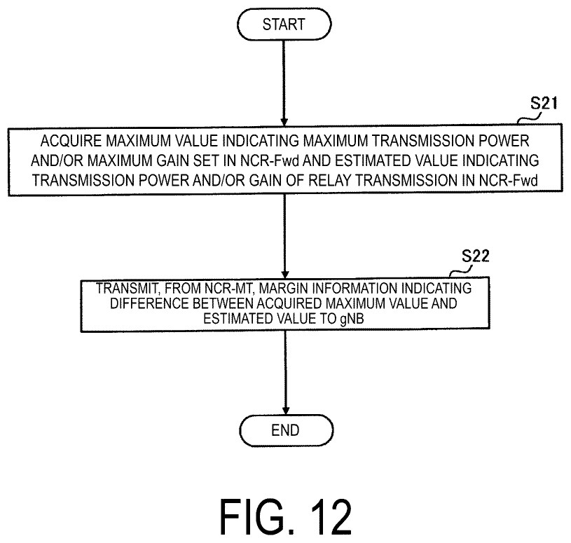

FIG. 12 is a flowchart illustrating a second basic operation of the NCR apparatus 500A according to the first embodiment. The second basic operation may be performed in combination with the first basic operation.

In step S21, the NCR apparatus 500A acquires a maximum value indicating a maximum transmission power and/or a maximum gain set in the NCR-Fwd 510A and an estimated value indicating a transmission power and/or a gain of relay transmission in the NCR-Fwd 510A. Here, the maximum transmission power and/or the maximum gain may be variable values (a maximum operating transmission power and a maximum operating gain) designated by the gNB 200 in the first basic operation. The maximum transmission power and/or the maximum gain may be fixed values determined depending on the capabilities of the NCR-Fwd 510A or legal regulations (for example, regulations under the Radio Law). The maximum transmission power and/or the maximum gain may be selectively applied to the lowest value of the variable value and the fixed value. The estimated value indicating the transmission power and/or the gain may be a measurement value (actual measurement value) obtained by measuring the transmission power and/or the gain. The estimated value may be a calculated value (theoretical value) obtained by a calculation formula for the transmission power and/or the gain.

In step S22, the NCR-MT 520A transmits margin information indicating a difference between the maximum value acquired in step S21 and the estimated value to the gNB 200 over the control link. The margin information may also be referred to as headroom information. The margin information may be a difference value indicating a difference between the maximum value acquired in step S21 and the estimated value, or an index thereof. The margin information may further include the maximum value acquired in step S21.

This allows the gNB 200 to understand the margin (remaining capacity) of the transmission power and/or the gain in the NCR apparatus 500A (the NCR-Fwd 510A) based on the margin information. Therefore, the gNB 200 is able to appropriately control the transmission power of the NCR-Fwd 510A. For example, the gNB 200 may understand the margin (remaining capacity) and then perform transmission power control using the above-mentioned second information and/or third information within the range of the margin (remaining capacity). The gNB 200 may perform resource scheduling for the NCR apparatus 500A based on the margin (remaining capacity). A specific example of an operation using the margin information will be described later in a fourth operation pattern.

In the NCR apparatus 500A that performs such an operation, based on a maximum value indicating the maximum transmission power and/or the maximum gain set in the NCR-Fwd 510A and an estimated value indicating the transmission power and/or the gain of the relay transmission in the NCR-Fwd 510A, the NCR-MT 520A transmits, to the gNB 200, margin information indicating a difference between the maximum value and the estimated value. On the other hand, the gNB 200 includes a receiver 220 that receives the margin information from the NCR-MT 520A.

In step S22, the NCR-MT 520A may transmit a medium access control/control element (MAC CE) including margin information to the gNB 200 over the control link.

The margin information may include power margin information indicating a difference between a maximum value indicating the maximum transmission power and an estimated value indicating the transmission power, and gain margin information indicating a difference between a maximum value indicating the maximum gain and an estimated value indicating the gain. Step S22 may include a step of transmitting a first MAC CE including the power margin information, and a step of transmitting a second MAC CE including the gain margin information. This allows power margin information and gain margin information to be transmitted independently to the gNB 200. Here, the first MAC CE may include a first logical channel identifier (LCID), and the second MAC CE may include a second LCID different from the first LCID. That is, the MAC CE including the power margin information (first MAC CE) and the MAC CE including the gain margin information (second MAC CE) may be identified by different LCIDs.

The second basic operation may further include a step in which the NCR-MT 520A receives, from the gNB 200, a signal that sets or requests the transmission of margin information. The NCR-MT 520A may transmit margin information to the gNB 200 based on the signal. The signal may include at least one of information for setting a timing of acquiring the maximum value and the estimated value or information for setting a transmission trigger for the margin information.

The margin information may be any one of the following 1) to 3).

1) Margin information regarding the uplink direction (uplink) from the NCR-Fwd 510A to the gNB 200:

In this case, in step S21, the NCR apparatus 500A may acquire a maximum value indicating the maximum transmission power and/or the maximum gain in the uplink direction, and an estimated value indicating the transmission power and/or the gain in the uplink direction.

2) Margin information regarding the downlink direction (downlink) from the NCR-Fwd 510A to the UE 100:

In this case, in step S21, the NCR apparatus 500A may acquire a maximum value indicating the maximum transmission power and/or the maximum gain in the downlink direction, and an estimated value indicating the transmission power and/or the gain in the downlink direction.

3) Overall margin information including both the uplink direction (uplink) and the downlink direction (downlink).

### (1.4.2) Specific Example of Operation

As specific examples of the operation of the mobile communication system 1 according to the first embodiment, a first operation pattern to a fourth operation pattern will be described. These operation patterns may be implemented individually or in combination of two or more.

### (1.4.2.1) First Operation Pattern

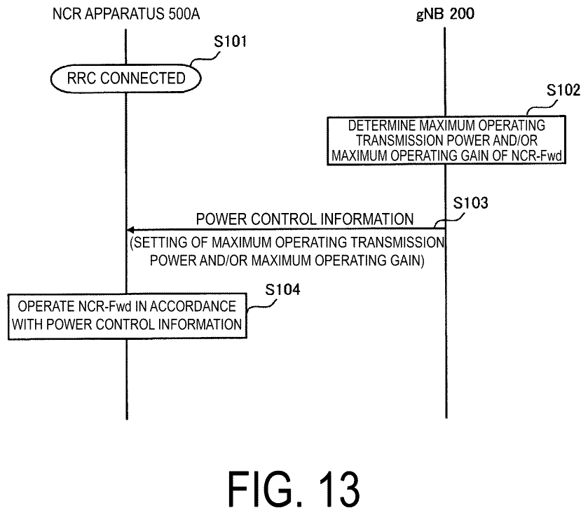

FIG. 13 is a flowchart illustrating an example of a first operation pattern of the mobile communication system 1 according to the first embodiment. In the first operation pattern, the gNB 200 sets the maximum operating transmission power and/or the maximum operating gain of the NCR-Fwd 510A to the NCR-MT 520A.

In step S101, the NCR-MT 520A of the NCR apparatus 500A is in an RRC connected state in a cell of the gNB 200.

In step S102, the gNB 200 determines the maximum operating transmission power and/or the maximum operating gain of the NCR-Fwd 510A of the NCR apparatus 500A. The gNB 200 may acquire capability information indicating the maximum transmission power and/or the maximum gain determined according to the capabilities of the NCR-Fwd 510A, and determine the maximum operating transmission power and/or the maximum operating gain so as not to exceed the maximum transmission power and/or the maximum gain. The gNB 200 may acquire the capability information from an Operation, Administration and Maintenance (OAM) entity. The gNB 200 may be acquired from the NCR-MT 520A. Here, the NCR-MT 520A may transmit an RRC message including capability information of the NCR-Fwd 510A to the gNB 200, and the gNB 200 may acquire the capability information included in the RRC message. For example, the gNB 200 may determine the maximum operating transmission power and/or the maximum operating gain of the NCR-Fwd 510A within the range of the allowable maximum transmission power of the NCR-Fwd 510A (maximum transmission power determined depending on the capabilities of the NCR-Fwd 510A or legal regulations) to curb interference to adjacent cells.

In step S103, the gNB 200 transmits power control information indicating the maximum operating transmission power and/or the maximum operating gain of the NCR-Fwd 510A determined in step S102 to the NCR-MT 520A. The NCR-MT 520A receives the power control information. Here, the gNB 200 may include the power control information in an RRC reconfiguration message, a MAC CE, or DCI and transmit it to the NCR-MT 520A. In the first operation pattern, the power control information may include at least one of the following information 1) to 4).

1) Maximum operating transmission power [dBm]:

This is information indicating the maximum operating transmission power of the NCR-Fwd 510A determined in step S102. The information may be an index of the maximum operating transmission power instead of the value of the maximum operating transmission power itself.

2) Maximum operating gain [dB]:

This is information indicating the maximum operating gain of the NCR-Fwd 510A determined in step S102. The information may be an index of the maximum operating gain instead of the value of the maximum operating gain itself.

3) Validity period:

This is information indicating the period during which the power control information in step S103 is valid. The information may be, for example, the value of an expiration monitoring timer, the number of valid radio frames, or the number of an invalid (or last valid) radio frame. The gNB 200 may designate a validity period to temporarily curb the maximum transmission power, for example, when the time required for interference curbing is limited.

### 4) NCR-Fwd ID (or may be NCR-RNTI):

When the NCR-MT 520A manages a plurality of NCR-Fwds 510A, this information is used to designate which NCR-Fwd 510A is the target.

In step S104, the NCR-MT 520A controls the transmission power of the NCR-Fwd 510A in accordance with the power control information received in step S103. The NCR-MT 520A may notify (set) the power control information received in step S103 to the NCR-Fwd 510A and cause the NCR-Fwd 510A to operate in accordance with the power control information. When the power control information includes a timer value indicating the validity period, the NCR-MT 520A may start a timer to which the timer value is set, and when the timer expires, determine that the power control information is invalid. When the NCR-MT 520A does not have valid power control information (for example, when power control information has not been received from the gNB 200 or the validity period has expired), the NCR-MT 520A may operate the NCR-Fwd 510A at the maximum transmission power and/or the maximum gain designated by its capabilities or the upper limit set by the Radio Law. The NCR-MT 520A may employ, as its maximum transmission power, the smaller of the maximum transmission power according to its capabilities or the upper limit set by the Radio Law and the maximum operating transmission power set by the gNB 200.

### (1.4.2.2) Second Operation Pattern

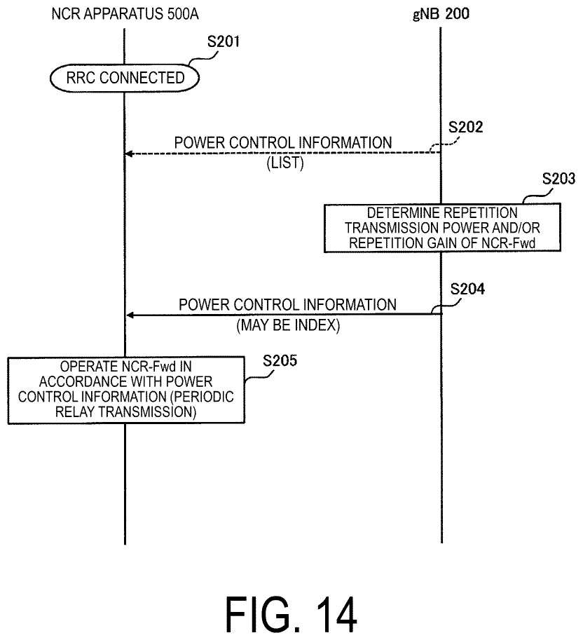

A second operation pattern will be described mainly focusing on the differences from the first operation pattern. FIG. 14 is a flowchart illustrating an example of the second operation pattern of the mobile communication system 1 according to the first embodiment. In the second operation pattern, the gNB 200 designates (notifies), to the NCR-MT 520A, the transmission power (repetition transmission power) and/or the gain (repetition gain) for periodic relay transmission by the NCR-Fwd 510A. The second operation pattern may be an operation that assumes that the maximum transmission power (or the maximum gain) is designated in the first operation pattern, or may be an operation that does not assume the first operation pattern.

In step S201, the NCR-MT 520A of the NCR apparatus 500A is in an RRC connected state in a cell of the gNB 200.

In step S202, the gNB 200 may transmit, to the NCR-MT 520A, power control information (first power control information) including a list in which a transmission power and/or a gain is associated with its index. The NCR-MT 520A may receive power control information. The gNB 200 may include the power control information in step S202 in an RRC Reconfiguration message and transmit it to the NCR-MT 520A. The list entry included in the power control information in step S202 may include at least one of the following information 1) to 4).

1) Setting ID (index):

This is an index indicating the corresponding transmission power and/or gain.

2) Transmission power [dBm] and/or gain [dB]:

This may be a range of transmission power and/or a range of transmission power.

### 3) NCR-Fwd ID (or may be NCR-RNTI):

When the NCR-MT 520A manages a plurality of NCR-Fwds 510A, this information is used to designate which NCR-Fwd 510A is the target.

4) Information about repetition period:

This information may also include a start timing (for example, a slot number) and repetition period (for example, the number of slots) of periodic relay transmission. This information may be bitmap information indicating each timing at which the repetition transmission power and/or the repetition gain is applied.

In step S203, the gNB 200 determines the repetition transmission power and/or the repetition gain of the NCR-Fwd 510A of the NCR apparatus 500A. The gNB 200 may determine the repetition transmission power and/or the repetition gain so as not to exceed the maximum transmission power and/or the maximum gain of the NCR-Fwd 510A.

In step S204, the gNB 200 transmits power control information (second power control information) indicating the repetition transmission power and/or the repetition gain determined in step S203 to the NCR-MT 520A. The NCR-MT 520A receives the power control information. The gNB 200 may include the power control information in step S204 in an RRC Reconfiguration message, a MAC CE, or DCI and transmit it to the NCR-MT 520A. The power control information in step S204 may include at least one of the following information 1) to 4).

1) Information about repetition period:

This information may also include a start timing (for example, a slot number) and repetition period (for example, the number of slots) of periodic relay transmission. This information may be bitmap information indicating each timing at which the repetition transmission power and/or the repetition gain is applied.

2) Information indicating repetition transmission power and/or repetition gain:

This information may be the actual value of the repetition transmission power [dBm] and/or the repetition gain [dB], or an index corresponding to any entry in the list in step S202. When the value of the repetition transmission power [dBm] and/or the repetition gain [dB] is notified, the value may be set in a different information element for each digit. For example, an information element for the tens digit and an information element for the ones digit may be defined separately, and the setting value may be expressed by a combination of these. In this case, for example, information element 1 is defined as {50, 40, 30, 20, 10, 0}, and information element 2 is defined as {9, 8, 7, . . . , 3, 2, 1, 0}, and the setting value is expressed as information element 1+information element 2. Values or indices indicating the repetition transmission power and/or the repetition gain may be listed, and each entry in the list may be associated with one slot.

3) Validity period:

This is information indicating the period during which the power control information in step S204 is valid. The information may be, for example, the value of an expiration monitoring timer, the number of valid radio frames, or the number of an invalid (or last valid) radio frame. The gNB 200 may designate a validity period to temporarily curb the maximum transmission power, for example, when the time required for interference curbing is limited.

### 4) NCR-Fwd ID (or may be NCR-RNTI):

When the NCR-MT 520A manages a plurality of NCR-Fwds 510A, this information is used to designate which NCR-Fwd 510A is the target.

In step S205, the NCR-MT 520A controls the transmission power of the NCR-Fwd 510A in the periodic relay transmission in accordance with the power control information received in step S204. The NCR-MT 520A may notify (set) the power control information received in step S204 to the NCR-Fwd 510A and cause the NCR-Fwd 510A to operate in accordance with the power control information. When the power control information includes a timer value indicating the validity period, the NCR-MT 520A may start a timer to which the timer value is set, and when the timer expires, determine that the power control information is invalid.

In the second operation pattern, even when the maximum operating transmission power (or the maximum operating gain) is set using the first operation pattern, the NCR-MT 520A may perform transmission power control by prioritizing the power control information received in step S204 at the timing of performing periodic relay transmission. For example, the NCR-MT 520A may apply the repetition transmission power (or the repetition gain) at the timing to perform relay transmission even when the repetition transmission power (or the repetition gain) at the timing exceeds the maximum operating transmission power (or the maximum operating gain). When the maximum operating transmission power (or the maximum operating gain) is set using the first operation pattern, the NCR-MT 520A may perform transmission power control by prioritizing the maximum operating transmission power (or the maximum operating gain) at the timing of performing periodic relay transmission. In this case, the NCR-Fwd 510A does not operate at a transmission power (or a gain) equal to or greater than the maximum operating transmission power (or the maximum operating gain).

When the NCR-MT 520A has not received the power control information in step S204 or at a timing when periodic relay transmission is not performed, the NCR-Fwd 510A may operate at the maximum operating transmission power (and/or the maximum operating gain). The NCR-Fwd 510A may not operate in any case beyond the maximum transmission power (and/or the maximum gain) set by its own capabilities (or the upper limit set by the Radio Law).

In the second operation pattern, an example has been described in which the repetition transmission power (and the repetition gain) is the transmission power (and the gain) applied in periodic relay transmission. However, the repetition transmission power (and the repetition gain) may be an upper limit of the transmission power (and the gain) applicable in periodic relay transmission. That is, the repetition transmission power (and the repetition gain) may be a maximum repetition transmission power (and a maximum repetition gain). In this case, the NCR apparatus 500A may autonomously determine the transmission power (and the gain) within a range not exceeding the maximum repetition transmission power (and the maximum repetition gain) at the timing of performing periodic relay transmission.

### (1.4.2.3) Third Operation Pattern

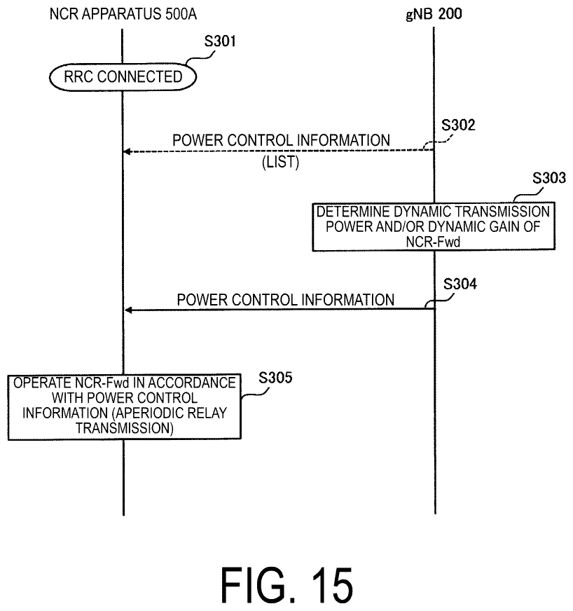

A third operation pattern will be described mainly focusing on the differences from the first and second operation patterns. FIG. 15 is a flowchart illustrating an example of the third operation pattern of the mobile communication system 1 according to the first embodiment. In the third operation pattern, the gNB 200 designates (notifies), to the NCR-MT 520A, the transmission power (dynamic transmission power) and/or the gain (dynamic gain) for aperiodic relay transmission of the NCR-Fwd 510A. The third operation pattern may be an operation that assumes that the maximum transmission power (or the maximum gain) is designated in the first operation pattern, or may be an operation that does not assume the first operation pattern.

In step S301, the NCR-MT 520A of the NCR apparatus 500A is in an RRC connected state in a cell of the gNB 200.

In step S302, the gNB 200 may transmit, to the NCR-MT 520A, power control information (first power control information) including a list in which a transmission power and/or a gain is associated with its index, and/or information indicating the timing of performing aperiodic relay transmission. The NCR-MT 520A may receive power control information. The gNB 200 may include the power control information in step S302 in an RRC Reconfiguration message and transmit it to the NCR-MT 520A. The list entry included in the power control information in step S302 may include at least one of the following information 1) to 4).

1) Setting ID (index):

This is an index indicating the corresponding transmission power and/or gain.

2) Transmission power [dBm] and/or gain [dB]:

This may be a range of transmission power and/or a range of transmission power.

### 3) NCR-Fwd ID (or may be NCR-RNTI):

When the NCR-MT 520A manages a plurality of NCR-Fwds 510A, this information is used to designate which NCR-Fwd 510A is the target.

4) Information indicating timing of performing aperiodic relay transmission:

This information may be a radio frame number, a subframe number, a slot number, and/or a symbol number.

In step S303, the gNB 200 determines the dynamic transmission power and/or the dynamic gain of the NCR-Fwd 510A of the NCR apparatus 500A. The gNB 200 may determine the dynamic transmission power and/or the dynamic gain so as not to exceed the maximum transmission power and/or the maximum gain of the NCR-Fwd 510A.

In step S304, the gNB 200 transmits power control information (second power control information) indicating the dynamic transmission power and/or the dynamic gain determined in step S303 to the NCR-MT 520A. The NCR-MT 520A receives the power control information. The gNB 200 may include the power control information in step S304 in an RRC Reconfiguration message, a MAC CE, or DCI and transmit it to the NCR-MT 520A. The power control information in step S304 may include at least one of the following information 1) to 3).

1) Information indicating timing of performing aperiodic relay transmission:

This information may be a radio frame number, a subframe number, a slot number, and/or a symbol number. The timing of performing aperiodic relay transmission may be determined in step S302, for example, by an RRC Reconfiguration message. The timing of performing aperiodic relay transmission may be determined in advance by specifications based on the timing of receiving the power control information in step S304 (for example, applied four slots after receiving a MAC CE).

2) Information indicating dynamic transmission power and/or dynamic gain:

This information may be the actual value of the dynamic transmission power [dBm] and/or the dynamic gain [dB], or an index corresponding to any entry in the list in step S302. When the value of the dynamic transmission power [dBm] and/or the dynamic gain [dB] is notified, the value may be set in a different information element for each digit.

### 3) NCR-Fwd ID (or may be NCR-RNTI):

When the NCR-MT 520A manages a plurality of NCR-Fwds 510A, this information is used to designate which NCR-Fwd 510A is the target.

In step S305, the NCR-MT 520A controls the transmission power of the NCR-Fwd 510A in the aperiodic relay transmission in accordance with the power control information received in step S304. The NCR-MT 520A may notify (set) the power control information received in step S304 to the NCR-Fwd 510A and cause the NCR-Fwd 510A to operate in accordance with the power control information. When the power control information includes a timer value indicating the validity period, the NCR-MT 520A may start a timer to which the timer value is set, and when the timer expires, determine that the power control information is invalid.

In the third operation pattern, even when the maximum operating transmission power (or the maximum operating gain) is set using the first operation pattern, the NCR-MT 520A may perform transmission power control by prioritizing the power control information received in step S304 at the timing of performing aperiodic relay transmission. For example, the NCR-MT 520A may apply the dynamic transmission power (or the dynamic gain) at the timing to perform relay transmission even when the dynamic transmission power (or the dynamic gain) at the timing exceeds the maximum operating transmission power (or the maximum operating gain). When the maximum operating transmission power (or the maximum operating gain) is set using the first operation pattern, the NCR-MT 520A may perform transmission power control by prioritizing the maximum operating transmission power (or the maximum operating gain) at the timing of performing aperiodic relay transmission. In this case, the NCR-Fwd 510A does not operate at a transmission power (or a gain) equal to or greater than the maximum operating transmission power (or the maximum operating gain).

When the NCR-MT 520A has not received the power control information in step S304 or at a timing when aperiodic relay transmission is not performed, the NCR-Fwd 510A may operate at the maximum operating transmission power (and/or the maximum operating gain). The NCR-Fwd 510A may not operate in any case beyond the maximum transmission power (and/or the maximum gain) set by its own capabilities (or the upper limit set by the Radio Law).

In the third operation pattern, an example has been described in which the dynamic transmission power (and the dynamic gain) is the transmission power (and the gain) applied in aperiodic relay transmission. However, the dynamic transmission power (and the dynamic gain) may be an upper limit of the transmission power (and the gain) applicable in aperiodic relay transmission. That is, the dynamic transmission power (and the dynamic gain) may be the maximum dynamic transmission power (and the maximum dynamic gain). In this case, the NCR apparatus 500A may autonomously determine the transmission power (and the gain) within a range not exceeding the maximum dynamic transmission power (and the maximum dynamic gain) at the timing of performing aperiodic relay transmission.

### (1.4.2.4) Fourth Operation Pattern

A fourth operation pattern will be described mainly focusing on the differences from the first to third operation patterns.

There is a concern that the gNB 200 may not have sufficient information when determining the transmission power (and/or the gain) of the NCR-Fwd 510A. For example, the transmission power of the NCR-Fwd 510A is determined according to the reception power of the NCR-Fwd 510A and the gain of the NCR-Fwd 510A. The reception power of the NCR-Fwd 510A varies depending on the installation position and/or the state of the transmission path. The gain of the NCR-Fwd 510A is limited by the reception power of the NCR-Fwd 510A and the maximum transmission power of the NCR-Fwd 510A. For example, assuming that the NCR apparatus 500A performs closed-loop control of the gain (for example, by monitoring the transmission power and controlling the gain) so as not to exceed the maximum transmission power (including the regulated value under the Radio Law), it is conceivable that the maximum gain of the NCR-Fwd 510A and the maximum gain that can actually be currently set (the gain for maintaining the maximum transmission power) may differ. The capability information of the NCR-Fwd 510A may not be provided to the gNB 200, and the gNB 200 may not be able to understand the maximum transmission power (and the gain) based on the capabilities of the NCR-Fwd 510A. Therefore, there is a concern that the gNB 200 may not be able to appropriately determine the transmission power (and/or the gain) of the NCR-Fwd 510A.

Therefore, in the fourth operation pattern, the NCR apparatus 500A acquires a maximum value indicating the maximum transmission power and/or the maximum gain set in the NCR-Fwd 510A and an estimated value indicating the transmission power and/or the gain of the relay transmission in the NCR-Fwd 510A, and transmits margin information indicating the difference between the acquired maximum value and estimated value to the gNB 200. This allows the gNB 200 to appropriately determine the transmission power (and/or the gain) of the NCR-Fwd 510A.

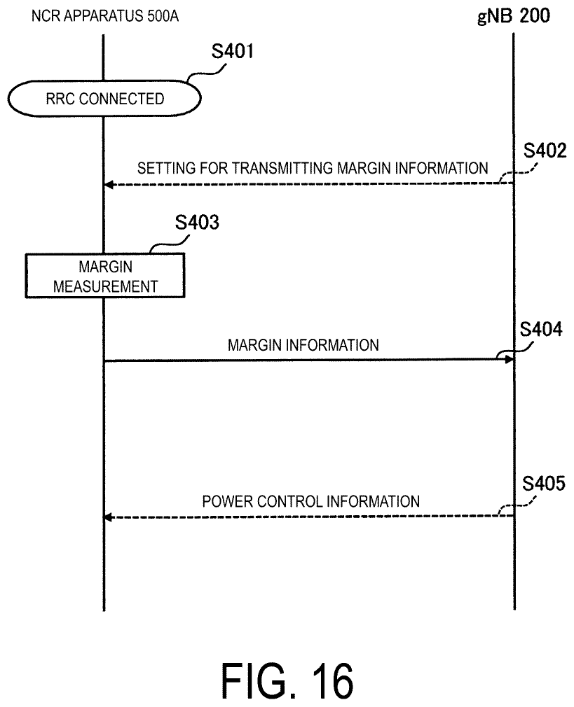

FIG. 16 is a flowchart illustrating an example of a fourth operation pattern of the mobile communication system 1 according to the first embodiment. The fourth operation example may be an operation pattern based on at least one of the first to third operation patterns.

In step S401, the NCR-MT 520A of the NCR apparatus 500A is in an RRC connected state in a cell of the gNB 200.

In step S402, the gNB 200 may transmit a setting (or a request) regarding the transmission of margin information to the NCR-MT 520A via an RRC Reconfiguration message, a MAC CE, or DCI. The NCR-MT 520A may receive a setting (or a request) regarding the transmission of margin information. The setting (or the request) may include at least one of the following information 1) to 4).

1) Information designating period (timing) of margin measurement:

For single measurements, the information may be a radio frame, a subframe, a slot, and/or a symbol number. For continuous measurements, the information may include a start frame number, an end frame number, and/or a period (for example, the number of slots).

2) Information designating transmission trigger and threshold value for margin information:

The NCR-MT 520A may transmit margin information to the gNB 200 when the measured margin or the reception status (RSRP/RSRQ/SINR) of the NCR-Fwd 510A satisfies threshold-value conditions designated in the information.

3) Information designating maximum transmission power (and/or maximum gain) to be used as a reference:

The reference may be either a maximum transmission power (or a maximum gain) depending on NCR capability or Radio Law, a maximum operating transmission power (or a maximum operating gain) designated by the gNB 200, a maximum repetition transmission power (or a maximum repetition gain), or a maximum dynamic transmission power (or a maximum dynamic gain).

4) Measurement object:

This information may be information designating a margin of a transmission power and/or a margin of a gain.

In step S402, the NCR apparatus 500A measures the margin of the transmission power (and/or the gain). Specifically, the NCR apparatus 500A derives the difference between the actual transmission power (and/or the gain) and the reference transmission power (and/or the gain) as the margin. When a measurement period is designated, the NCR apparatus 500A performs margin measurement during the designated measurement period. When the measurement period is not designated, the NCR apparatus 500A may measure the margin for a predetermined section, such as the past one radio frame. The NCR apparatus 500A may use a statistical value (an average value, a maximum value, or a minimum value) of the results of a plurality of measurements taken during the measurement period/measurement section as a measurement value of the margin. The NCR-Fwd 510A may perform the measurement and notify the NCR-MT 520A of the measurement results. In this case, the NCR-MT 520A may set the measurement to be performed by the NCR-Fwd 510A.

In step S403, the NCR-MT 520A transmits margin information indicating the results of the margin measurement in step S402 to the gNB 200. The gNB 200 receives margin information. The NCR-MT 520A may include the margin information in a MAC CE, an RRC message (for example, a Measurement Report message), or uplink control information (UCI) and transmit it to the gNB 200. When the MAC CE is used, the transmission power margin and the gain margin may be identified by different LCIDs, with the MAC CE format being common to both. The margin information includes the following information 1) and/or 2).

1) Margin measurement value:

The margin measurement value may be included in the margin information as a series of a plurality of values. In this case, the mapping relationship may be such that the first measurement value is slot #1, the second measurement value is slot #2, and so on.

The margin measurement value may be determined by the specifications to be the measurement value of the slot k slots before (for example, the measurement value of the slot four slots before). When the margin information includes only one margin measurement value, if the transmission timing of the margin information is slot n, for example, the margin measurement value is the measurement value of slot (n−4). On the other hand, when the margin information includes a plurality of margin measurement values, the mapping relationship may be such that the first measurement value is slot (n−4), the second measurement value is slot (n−5), the third measurement value is slot (n−6), and so on, or the mapping relationship, such as n−4, n−3, n−2, n−1 from the first measurement value, may also be used. A starting point of the first measurement value (m slots before) may be determined, and based on that starting point, the mapping relationship may be such that the first measurement value is slot n−m, the second measurement value is slot n−(m−1), the third measurement value is slot n−(m−2), and so on. These mapping relationships are merely examples, and the reverse mapping relationships, such as n−m, n-(m+1), and n-(m+2), may also be used.

2) Information indicating timing or period of measurement:

For single measurements, the information may be a radio frame, a subframe, a slot, and/or a symbol number. For continuous measurements, the information may include a start frame number, an end frame number, and/or a period (for example, the number of slots).

In step S405, the gNB 200 may determine the transmission power (and/or the gain) of the NCR-Fwd 510A based on the margin information received from the NCR-MT 520A in step S404, and may designate the transmission power (and/or the gain) of the NCR-Fwd 510A to the NCR-MT 520A in the same manner as the second operation pattern or the third operation pattern.

In the operation example of FIG. 16, it is assumed that NCR-MT 520A is in the RRC connected state, but the NCR apparatus 500A that performs relay transmission in the RRC inactive state (or the RRC idle state) may also perform the margin measurement in step S402. In this case, the NCR apparatus 500A may store the margin measurement value as a log and transmit the log to the gNB 200 after transitioning to the RRC connected state. The log may include additional information such as the cell ID of the cell at the time of measuring the margin and/or a timestamp indicating the time at which the margin was measured.

### (2) Second Embodiment

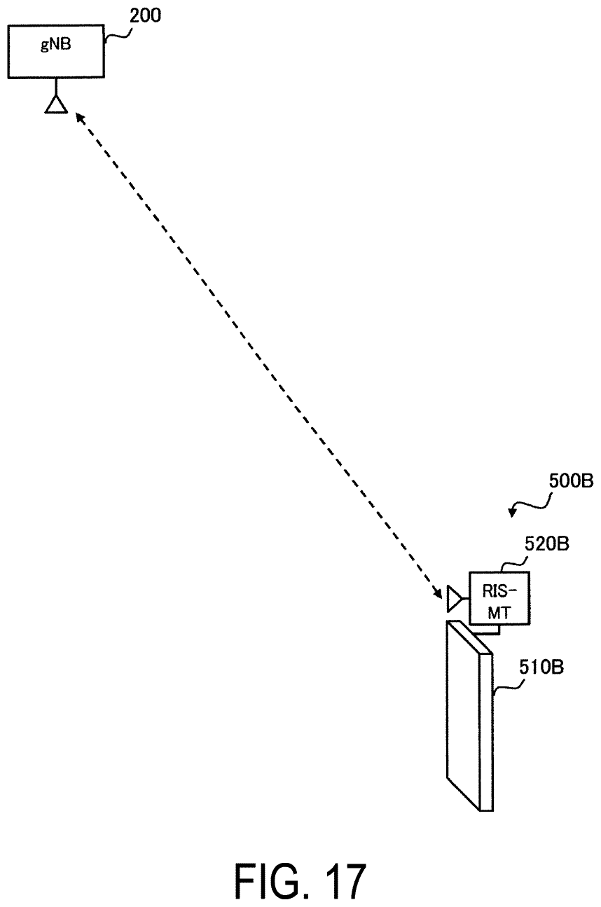

Next, the second embodiment will be described mainly focusing on the differences from the above-described embodiment. As illustrated in FIG. 17, the relay apparatus according to the second embodiment is a reconfigurable intelligent surface (RIS) apparatus 500B that performs relay transmission by changing a propagation direction of incident radio waves (radio signals) through reflection or refraction. The “NCR” in the above-described embodiments may be read as “RIS”.

The RIS is a type of relay device (hereinafter, also referred to as “RIS-Fwd”) capable of performing beamforming (directivity control) similar to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling a RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects incident radio waves to change a propagation direction of the radio waves. Here, a reflection angle of the radio waves can be variably set. The RIS-Fwd 510B reflects radio waves incident from the gNB 200 toward the UE 100. The RIS-Fwd 510B may be a transmissive RIS. Such an RIS-Fwd 510B refracts incident radio waves to change the propagation direction of the radio waves. Here, a refraction angle of the radio wave can be variably set.

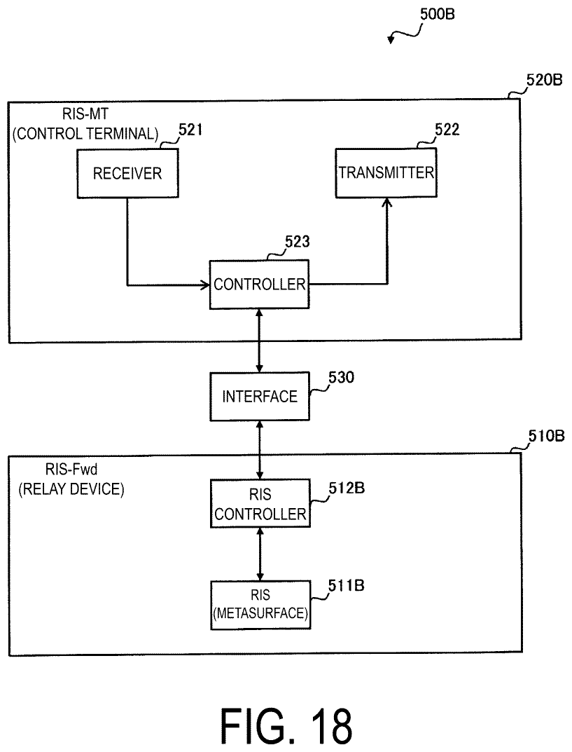

FIG. 18 is a diagram illustrating examples of configurations of the RIS-Fwd (relay device) 510B and the RIS-MT (control terminal) 520B according to the second embodiment. The RIS-MT 520B includes a receiver 521, a transmitter 522, and a controller 523. Such a configuration is similar to the above-described embodiment. The RIS-Fwd 510B includes a RIS 511B and a RIS controller 512B. The RIS 511B is a metasurface configured using a metamaterial. For example, the RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting incident radio waves, a mode of transmitting some of radio waves and reflecting some of them, and a mode of reflecting all radio waves by minutely moving the stacked glass substrate. The RIS controller 512B controls the RIS 511B in response to a RIS control signal from the controller 523 of the RIS-MT 520B. The RIS controller 512B may include at least one processor and at least one actuator. The processor decodes a RIS control signal from the controller 523 of the RIS-MT 520B and drives the actuator in response to the RIS control signal.

In the second embodiment, the transmission power control in the RIS-Fwd 510B may include controlling the reflectance, attenuation rate, and/or transmittance in the RIS-Fwd 510B. That is, the transmission power (and the gain) of the RIS-Fwd 510B may be controlled by changing the reflectance, attenuation rate, and/or transmittance of the RIS-Fwd 510B.

### (3) Another Embodiment

In the above-described embodiment, an example in which the relay apparatus that performs relay transmission is the NCR apparatus 500A or the RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

The above-described operational flows are not limited to being carried out independently, but may be carried out by combining two or more operational flows. For example, some steps of one operational flow may be added to another operational flow, or some steps of one operational flow may be replaced with some steps of another operational flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a distributed unit (DU) of the IAB node. The UE 100 may be a mobile termination (MT) of the IAB node.

That is, the UE 100 may be a terminal function unit (a type of communication module) for a base station to control a relay device that performs signal relay. Such terminal function unit is referred to as an MT. Examples of the MT include, a Network Controlled Repeater (NCR)-MT and a Reconfigurable Intelligent Surface (RIS)-MT, in addition to the IAB-MT.

The term “network node” mainly means a base station, but may also mean a core network apparatus or a part of the base station (CU, DU, or RU). The network node may include a combination of at least a part of the core network apparatus and at least a part of the base station.

A program causing a computer to execute each of the processes performed by the communication apparatus according to the embodiment described above, for example, the UE 100 (NCR-MT 520A and RIS-MT 520B) or the gNB 200 may be provided. The program may be recorded on a computer-readable medium. The computer-readable medium allows the program to be installed on a computer. Here, the computer-readable medium on which the program is recorded may be a non-transitory recording medium. The non-transitory recording medium is not particularly limited, but may be, for example, a recording medium such as a CD-ROM or a DVD-ROM. Circuits for executing each process performed by the UE 100 or the gNB 200 may be integrated, and at least a part of the UE 100 or the gNB 200 may be implemented as a semiconductor integrated circuit (chipset, System on a chip (SoC)).

The functions achieved by the UE 100 or the gNB 200 (the network node) may be implemented in circuitry or processing circuitry programmed to realize the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered to be circuitry or processing circuitry. The processor may be a programmed processor that executes a program stored in the memory. In this specification, circuitry, unit, or means is hardware that is programmed to realize or executes the described functions. The hardware may be any hardware disclosed herein or any hardware known to be programmed to realize or capable of executing the described functions. When the hardware is a processor that is considered to be a type of circuitry, the circuitry, means, or unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. Similarly, the phrase “depending on/in response to” means both “only depending on/only in response to” and “at least partially depending on/at least partially in response to”. The terms “include”, “comprise”, and variations thereof do not mean to include only the items listed, but may include only the items listed, or may include additional items in addition to the items listed. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed therein or that the first element needs to precede the second element in some way. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (4) Supplementary Notes

Features relating to the embodiments described above are described below as supplementary notes.

### Supplementary Note 1

A communication method executed by a relay apparatus including a relay device that performs relay transmission of relaying a radio signal transmitted between a network node and a user equipment, and a control terminal used to control the relay device, the communication method including the steps of:
receiving, by the control terminal, power control information configured to control a transmission power of the relay transmission from the network node; and
performing, by the relay device, the relay transmission at the transmission power based on the power control information,
in which the power control information includes at least one selected from the group consisting of first information indicating a maximum transmission power and/or a maximum gain to be set in the relay device, second information indicating a transmission power and/or a gain in periodic relay transmission, and third information indicating a transmission power and/or a gain in aperiodic relay transmission.

### Supplementary Note 2

The communication method according to Supplementary Note 1, in which the receiving includes receiving at least one selected from the group consisting of a radio resource control (RRC) message including the power control information, a medium access control/control element (MAC CE) including the power control information, and downlink control information (DCI) including the power control information.

### Supplementary Note 3

The communication method according to Supplementary Note 1 or 2, in which the power control information is information configured to control the transmission power in a downlink direction from the relay device to the user equipment.

### Supplementary Note 4

The communication method according to any one of Supplementary Notes 1 to 3, in which the power control information is information configured to control the transmission power in an uplink direction from the relay device to the network node.

### Supplementary Note 5

The communication method according to any one of Supplementary Notes 1 to 4, in which the power control information includes information designating a period during which transmission power control in accordance with the power control information is to be applied, and
the performing of the relay transmission includes performing the relay transmission at the transmission power based on the power control information during the designated period.

### Supplementary Note 6

The communication method according to any one of Supplementary Notes 1 to 5, in which the receiving includes the steps of:
receiving first power control information including a setting list in which setting values of a transmission power or a gain are associated with indices indicating the setting values; and
receiving second power control information including the indices, and
the performing of the relay transmission includes the steps of:
specifying the setting value corresponding to the index included in the second power control information based on the setting list; and
performing transmission power control using the specified setting value.

### Supplementary Note 7

The communication method according to any one of Supplementary Notes 1 to 6, in which the power control information includes the first information, and
the performing of the relay transmission includes performing the relay transmission so as not to exceed the maximum transmission power and/or the maximum gain based on the first information.

### Supplementary Note 8

The communication method according to any one of Supplementary Notes 1 to 7, in which the power control information includes the second information, and
the performing of the relay transmission includes performing the periodic relay transmission at the transmission power based on the second information.

### Supplementary Note 9

The communication method according to any one of Supplementary Notes 1 to 8, in which the power control information includes the third information, and
the performing of the relay transmission includes performing the aperiodic relay transmission at the transmission power based on the third information.

### Supplementary Note 10

A relay apparatus including:
a relay device configured to perform relay transmission of relaying a radio signal transmitted between a network node and a user equipment; and
a control terminal used to control the relay device,
in which the control terminal receives power control information configured to control a transmission power of the relay transmission from the network node,
the relay device performs the relay transmission at the transmission power based on the power control information, and
the power control information includes at least one selected from the group consisting of first information indicating a maximum transmission power and/or a maximum gain to be set in the relay device, second information indicating a transmission power and/or a gain in periodic relay transmission, and third information indicating a transmission power and/or a gain in aperiodic relay transmission.

### Supplementary Note 11

A network node for communicating with a relay apparatus including a relay device that performs relay transmission of relaying a radio signal transmitted between the network node and a user equipment, and a control terminal used to control the relay device, the network node including:
a controller configured to generate power control information configured to control transmission power of the relay transmission; and
a transmitter configured to transmit the power control information to the control terminal, in which the power control information includes at least one selected from the group consisting of first information indicating a maximum transmission power and/or a maximum gain to be set for the relay device, second information indicating a transmission power and/or a gain in periodic relay transmission, and third information indicating a transmission power and/or a gain in aperiodic relay transmission.

### Supplementary Note 12

A communication method executed by a relay apparatus including a relay device that performs relay transmission of relaying a radio signal transmitted between a network node and a user equipment, and a control terminal used to control the relay device, the communication method including the steps of:
acquiring a maximum value indicating a maximum transmission power and/or a maximum gain set in the relay device, and an estimated value indicating a transmission power and/or a gain of the relay transmission in the relay device; and
transmitting margin information indicating a difference between the maximum value and the estimated value from the control terminal to the network node.

### Supplementary Note 13

The communication method according to Supplementary Note 12, in which the transmitting includes transmitting a medium access control/control element (MAC CE) including the margin information.

### Supplementary Note 14

The communication method according to Supplementary Note 13, in which the margin information includes:
power margin information indicating a difference between the maximum value indicating the maximum transmission power and the estimated value indicating the transmission power; and
gain margin information indicating a difference between the maximum value indicating the maximum gain and the estimated value indicating the gain, and
the transmitting includes the steps of:
transmitting a first MAC CE including the power margin information; and
transmitting a second MAC CE including the gain margin information.

### Supplementary Note 15

The communication method according to Supplementary Note 14, in which the first MAC CE includes a first logical channel identifier (LCID), and
the second MAC CE includes a second LCID that is different from the first LCID.

### Supplementary Note 16

The communication method according to any one of Supplementary Notes 12 to 15, further including:
receiving, by the control terminal, from the network node, a signal that sets or requests transmission of the margin information,
in which the transmitting includes transmitting the margin information from the control terminal to the network node based on the signal.

### Supplementary Note 17

The communication method according to Supplementary Note 16, in which the signal includes at least one of information configured to set a timing of acquiring the maximum value and the estimated value or information configured to set a transmission trigger for the margin information.

### Supplementary Note 18

The communication method according to any one of Supplementary Notes 12 to 17, in which the maximum value indicates the maximum transmission power and/or the maximum gain in an uplink direction from the relay device to the network node, and
the estimated value indicates the transmission power and/or the gain in the uplink direction.

### Supplementary Note 19

The communication method according to any one of Supplementary Notes 12 to 17, in which the maximum value indicates the maximum transmission power and/or the maximum gain in a downlink direction from the relay device to the user equipment, and
the estimated value indicates the transmission power and/or the gain in the downlink direction.

### Supplementary Note 20

A relay apparatus including:
a relay device configured to perform relay transmission of relaying a radio signal transmitted between a network node and a user equipment; and
a control terminal used to control the relay device,
in which the control terminal transmits, to the network node, based on a maximum value indicating a maximum transmission power and/or a maximum gain set in the relay device, and an estimated value indicating a transmission power and/or a gain of the relay transmission in the relay device, margin information indicating a difference between the maximum value and the estimated value.

### Supplementary Note 21

A network node for communicating with a relay apparatus including a relay device that performs relay transmission of relaying a radio signal transmitted between the network node and a user equipment, and a control terminal used to control the relay device, the network node including:
a receiver configured to receive, from the control terminal, margin information based on a maximum value indicating a maximum transmission power and/or a maximum gain set in the relay device, and an estimated value indicating a transmission power and/or a gain of the relay transmission in the relay device,
in which the margin information is information indicating a difference between the maximum value and the estimated value.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A: NCR-Fwd
520A: NCR-MT
500B: RIS apparatus
510B: RIS-Fwd
520B: RIS-MT
511A: Wireless unit
511a: Antenna section
511b: RF circuit
511c: Directivity controller
512A: NCR controller
512B: RIS controller
521: Receiver
522: Transmitter
523: Controller
530: Interface

1. A communication method executed by a relay apparatus comprising a relay device that performs relay transmission of relaying a radio signal transmitted between a network node and a user equipment, and a control terminal used to control the relay device, the communication method comprising:
acquiring a maximum value indicating a maximum transmission power and/or a maximum gain set in the relay device, and an estimated value indicating a transmission power and/or a gain of the relay transmission in the relay device; and
transmitting margin information indicating a difference between the maximum value and the estimated value from the control terminal to the network node.

2. The communication method according to claim 1, wherein the transmitting comprises transmitting a medium access control/control element (MAC CE) comprising the margin information.

3. The communication method according to claim 2, wherein
the margin information comprises:
power margin information indicating a difference between the maximum value indicating the maximum transmission power and the estimated value indicating the transmission power; and
gain margin information indicating a difference between the maximum value indicating the maximum gain and the estimated value indicating the gain, and
the transmitting comprises:
transmitting a first MAC CE comprising the power margin information; and
transmitting a second MAC CE comprising the gain margin information.

4. The communication method according to claim 3, wherein
the first MAC CE comprises a first logical channel identifier (LCID), and
the second MAC CE comprises a second LCID that is different from the first LCID.

5. The communication method according to claim 1, further comprising:
receiving, by the control terminal, from the network node, a signal that sets or requests transmission of the margin information,
wherein the transmitting comprises transmitting the margin information from the control terminal to the network node based on the signal.

6. The communication method according to claim 5, wherein the signal comprises at least one of information configured to set a timing of acquiring the maximum value and the estimated value or information configured to set a transmission trigger for the margin information.

7. The communication method according to claim 1, wherein
the maximum value indicates the maximum transmission power and/or the maximum gain in an uplink direction from the relay device to the network node, and
the estimated value indicates the transmission power and/or the gain in the uplink direction.

8. The communication method according to claim 1, wherein
the maximum value indicates the maximum transmission power and/or the maximum gain in a downlink direction from the relay device to the user equipment, and
the estimated value indicates the transmission power and/or the gain in the downlink direction.

9. A relay apparatus comprising:
a relay device configured to perform relay transmission of relaying a radio signal transmitted between a network node and a user equipment; and
a control terminal used to control the relay device,
wherein the control terminal transmits, to the network node, based on a maximum value indicating a maximum transmission power and/or a maximum gain set in the relay device, and an estimated value indicating a transmission power and/or a gain of the relay transmission in the relay device, margin information indicating a difference between the maximum value and the estimated value.

10. A network node for communicating with a relay apparatus comprising a relay device that performs relay transmission of relaying a radio signal transmitted between the network node and a user equipment, and a control terminal used to control the relay device, the network node comprising:
a receiver configured to receive, from the control terminal, margin information based on a maximum value indicating a maximum transmission power and/or a maximum gain set in the relay device, and an estimated value indicating a transmission power and/or a gain of the relay transmission in the relay device,
wherein the margin information is information indicating a difference between the maximum value and the estimated value.
